(19) United States
(12) Patent Application Publication
(10) Pub. No.: US 2026/0156339 A1
(43) Pub. Date: Jun. 4, 2026

(54) ALIGNMENT TOOL FOR COMPUTER NUMERICAL CONTROL MACHINING

(71) Applicant: Theory 168 LLC, Grantsburg, WI (US)

(72) Inventor: Benjamin Douglas York, Grantsburg, WI (US)

(21) Appl. No.: 19/407,899

(22) Filed: Dec. 3, 2025

Related U.S. Application Data
(60) Provisional application No. 63/727,629, filed on Dec. 3, 2024.

(51) Int. Cl. H04N 23/54; H04N 23/51; H04N 23/695

(52) U.S. Cl. CPC H04N 23/54; H04N 23/51; H04N 23/695

(57) ABSTRACT

An alignment tool includes a camera assembly and a computing device. The camera assembly is configured to be installed offset from a rotational axis. The computing device is in communication with the camera assembly and configured to determine a directional offset of a tool presented to the camera assembly relative to the rotational axis.

### CROSS-REFERENCES TO RELATED APPLICATIONS

This application claims priority under 35 U.S.C. § 119 to U.S. Provisional Patent Application No. 63/727,629 filed on December 3, 2024, the entire contents of which are incorporated herein by reference.

### BACKGROUND

When performing computer numerical control machining, tools must be located in three-dimensional space relative to a workpiece. Traditionally, this is accomplished by skilled technicians using gauges, which is often time-consuming and laborious.

### SUMMARY

Some embodiments provide an alignment tool that includes a camera assembly and a computing device. The camera assembly is configured to be installed offset from a rotational axis. The computing device is in communication with the camera assembly and is configured to determine a directional offset of a tool presented to the camera assembly relative to the rotational axis.

In some embodiments, the camera assembly is supported by a mounting frame.

In some embodiments, the mounting frame includes an arcuate mounting section.

In some embodiments, the camera assembly includes a camera translatably moveable in a direction substantially perpendicular to the rotational axis.

In some embodiments, translating the camera along the direction focuses the camera.

In some embodiments, a motor translates the camera via an adjustment screw.

In some embodiments, a camera focus slider supports the camera, is threadably engaged with the adjustment screw, and is slidably engaged with a slider bar.

In some embodiments, the camera assembly includes a prism configured to orthogonally turn light entering the camera assembly.

In some embodiments, the prism presents images to a camera in a direction orthogonal to the rotational axis.

In some embodiments, the camera is slidably supported by a mounting frame, and the prism is supported by the mounting frame.

In some embodiments, the camera assembly includes a selectively openable window cover.

In some embodiments, a motor opens the window cover via an orthogonal drive.

In some embodiments, the window cover defines an opening configured to selectively align with a camera aperture.

In some embodiments, the camera aperture reveals a prism.

In some embodiments, the computing device is configured to align the tool with a workpiece mounted along the rotational axis based on the directional offset.

Some embodiments provide a camera assembly that includes a case, a camera, a prism, and a window cover. The camera is translatably supported by the case. The prism is aligned with the camera. The window cover is rotatably mounted to the case and configured to selectively reveal the prism.

In some embodiments, the camera is drivably connected to a focus motor and the window cover is drivably connected to a window motor.

In some embodiments, a frame mount connected to the case supports the camera, the prism, the focus motor, and the window motor.

Some embodiments provide a method to align a tool gang within a lathe system, where the method includes rotating a spindle of the lathe system; determining a rotational axis of the spindle based on images from a first camera; aligning a tool mounted in the tool gang with the rotational axis based on images from the first camera; aligning the tool with an alignment template based on images from a second camera; and determining a directional offset between the tool and the rotational axis.

In some embodiments, the method also includes aligning the tool with a workpiece mounted in the spindle based on the directional offset.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 illustrates a lathe system, according to an embodiment;

FIG. 2 is an isometric view of a tool alignment device of the lathe system of FIG. 1 ;

FIG. 3 is a front view of a camera assembly of the tool alignment device of FIG. 2 ;

FIG. 4 is a rear view of the camera assembly of FIG. 3;

FIG. 5 is a partial isometric view of a mounting frame of the tool alignment device of FIG. 2 ;

FIG. 6 is a block diagram of electronic components of the lathe system of FIG. 1 ;

FIG. 7 illustrates an interface of the lathe system of FIG. 1;

FIG. 8 is a flow diagram depicting a method to align a tool gang within the lathe system of FIG. 1, according to the principles of this disclosure;

FIG. 9 is an isometric view of a tool alignment device useable with the lathe system of FIG. 1;

FIG. 10 is a front view of a camera assembly of the tool alignment device of FIG. 9 ;

FIG. 11 is a rear view of the camera assembly of FIG. 10 ; and

FIG. 12 is an isometric view of a tool alignment device useable with the lathe system of FIG. 1.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

As mentioned above, traditional tools and methods to locate tools in three-dimensional space for computer numerical control machining is often inefficient and difficult. Thus, it would be useful to provide more sophisticated and versatile devices and methods to locate and align machine tools.

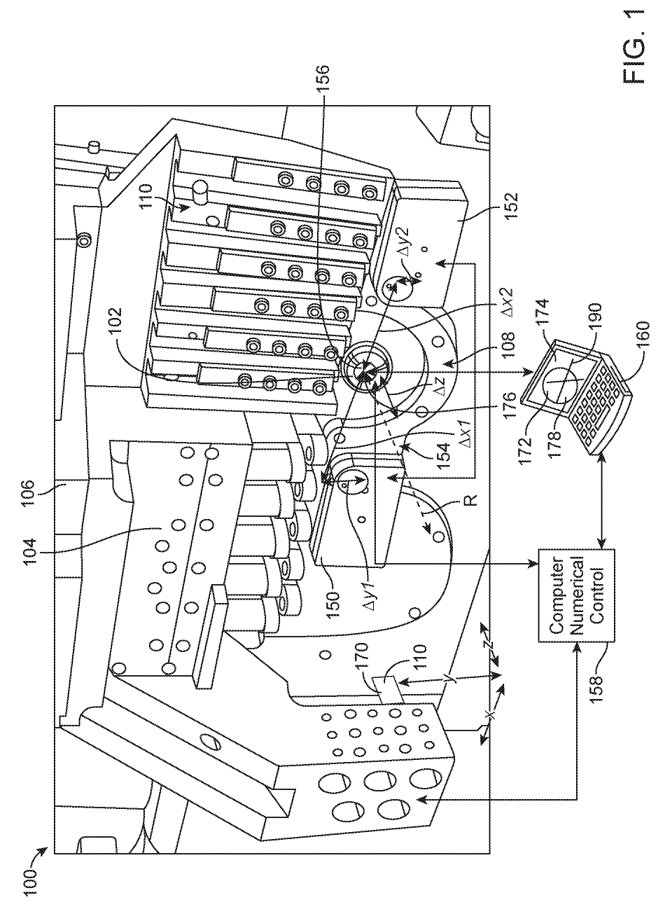

FIG. 1 illustrates a lathe system 100 according to an embodiment. The lathe system 100 includes tool gang 102 and a spindle 104 mounted to a body 106. The lathe system 100 also includes a tool alignment device 108 mounted to the body 106. The tool gang 102 is translatably and/or slidably moveable relative to the body 106 in a first direction x (e.g., side to side) and in a second direction y (e.g., up and down). The tool gang 102 is configured to hold a plurality of tools 110 (e.g., drill bits, cutting tools, parting tools, etc.). The spindle 104 rotates relative to the tool gang 102 and the body 106. The spindle 104 is configured to hold a workpiece (not shown), which is moved in a third direction z (e.g., in and out, advance, retract, etc.) to variably axially extend from the spindle 104. Thus, as the spindle 104 rotates, the workpiece may be axially introduced to one or more tools 110 and/or one or more tools 110 may be radially introduced to the workpiece to remove material from the workpiece until a desired geometry is reached (e.g., a screw, a plunger, a valve, etc.).

Remaining with FIG. 1, the tool alignment device 108 includes a left camera assembly 150 and a right camera assembly 152 supported by a mounting frame 154, which is mounted to the body 106. A center camera 156 is removably mounted to the spindle 104. The lathe system 100 further includes a computer numerical control (CNC) 158 that communicates with and controls the tool gang 102 and the spindle 104. More specifically, the CNC 158 controls translation of the tool gang 102, rotation of the spindle 104, and extension of the workpiece from the spindle 104. Additionally, a computing device 160 (e.g., laptop computer, desktop computer, smartphone, handheld device, etc.) communicates with the left camera assembly 150, the right camera assembly 152, the center camera 156, and the CNC 158.

Looking again at FIG. 1, in operation, during an initial alignment and/or calibration of the lathe system 100, a target 170 is mounted to the tool gang 102, which is translated to present the target 170 to the center camera 156. An image 172 of the target 170 is shown to a user via a display 174 of the computing device 160. As the CNC 158 instructs the spindle 104 to slowly rotate relative to the target 170, the computing device 160 analyzes the image 172 by differentiating light and dark pixels to find a rotation center 176 of the spindle 104. Thus, a rotation projection point 178 on the target 170, visible to the user via the image 172, and the rotation center 176 are located along a rotation axis R of the spindle 104.

Referring again to FIG. 1, after finding the rotation center 176 and the rotation axis R, the target 170 may be removed to from the tool gang 102 and replaced with one of the tools 110. Based on commands from the CNC 158, the tool gang 102 may then be translated to present the tool 110 to the center camera 156 and align a feature of the tool 110 (e.g., a tip, a corner, an edge, a radius, etc.) with the rotation projection point 178. Additionally, the computing device 160 may focus the center camera 156 on the tool 110 to determine a third direction offset Δz based on a focal length between the center camera 156 and the tool 110. Thus, the tool 110 is colinear with the rotation axis R in the first direction x and in the second direction y and located along the rotation axis R in the third direction z, often referred to as “zeroed.” Further, when tool 110 is presented to the center camera 156 and zeroed, the feature of the tool 110 may represent the coordinate origin point (e.g., 0, 0, 0) of the lathe system 100.

With further reference to FIG. 1, after aligning the tool 110 with the rotation axis R, the center camera 156 may be removed. Further, the CNC 158 may instruct the tool gang 102 to translate and/or adjust to present the tool 110 to the left camera assembly 150 and/or the right camera assembly 152 such that the tool 110 is aligned with an alignment template 190 (e.g., reticle, crosshair, etc.). in the display 174. As the tool gang 102 translates the tool 110 to align with the left camera assembly 150, the CNC 158 measures and records a left first direction offset Δx1 and left second direction offset Δy1 relative to the rotation axis R. Similarly, as the tool gang 102 translates the tool 110 to align with the right camera assembly 152, the CNC 158 measures and records a right first direction offset Δx2 and right second direction offset Δy2 relative to the rotation axis R. Thus, the CNC 158 may repeatedly align the tool 110 with one or more workpieces loaded into the spindle 104 by translating the tool gang 102 according to the left first direction offset Δx1, the left second direction offset Δy1, the right first direction offset Δx2, and the right second direction offset Δy2 relative to the left camera assembly 150 and the right camera assembly 152, respectively. Consequently, the tool 110 may be subsequently and/or repetitively aligned with multiple workpieces without the center camera 156.

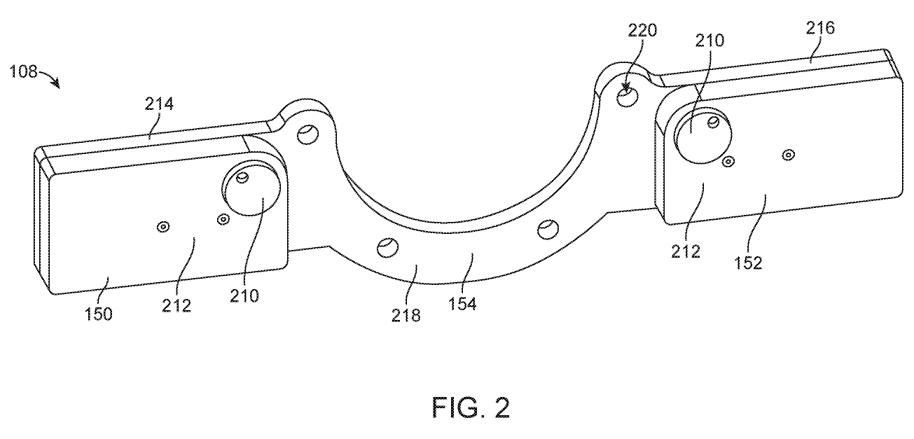

Turning to FIG. 2, the left camera assembly 150 and the right camera assembly 152 are substantially mirror images of one another and thus include reversed, but functionally identical components. Thus, the left camera assembly 150 and the right camera assembly 152 each include a window cover 210 rotatably mounted to a case 212. The left camera assembly 150 is mounted to a first flange 214. Similarly, the right camera assembly 152 is mounted to a second flange 216. A mounting section 218 connects the first flange 214 and the second flange 216. The mounting section 218 defines a plurality of openings 220 through which threaded fasteners (not shown) may extend. In some embodiments, the mounting section 218 is arcuate (e.g., circular, ovoid, elliptical, non-polygonal, etc.).

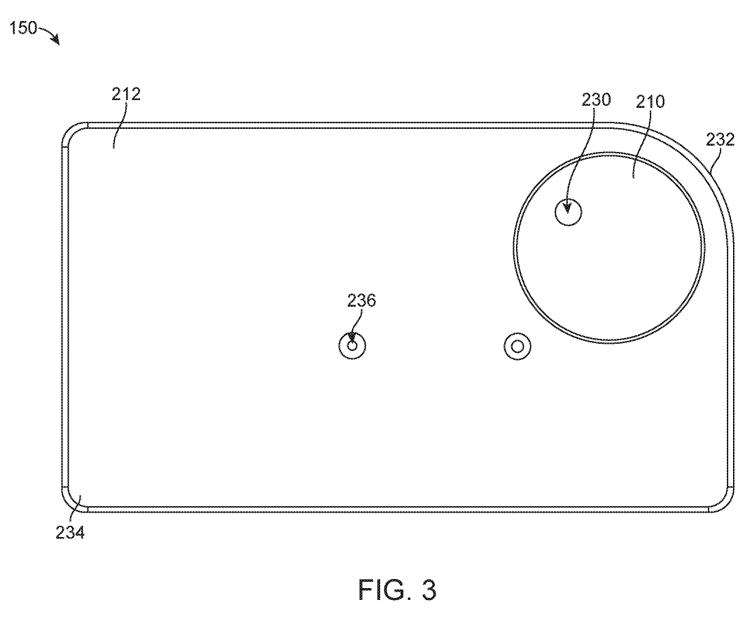

With reference to FIG. 3, in the left camera assembly 150, the window cover 210 defines an opening 230. The case 212 includes a curved corner 232 and rounded corners 234. The curved corner 232 is concentrically curved with the window cover 210. Additionally, the case 212 defines mounting openings 236.

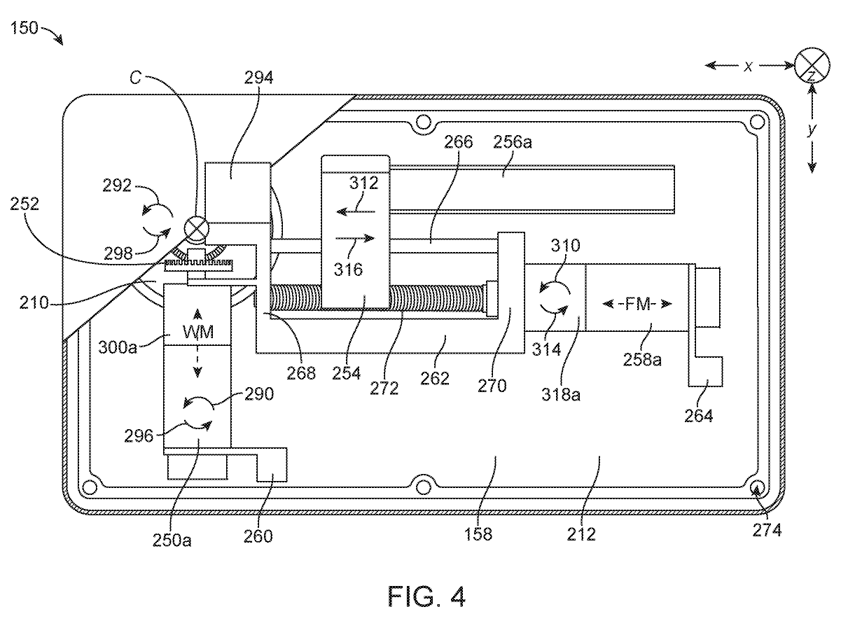

With reference to FIG. 4, the left camera assembly 150 further includes a window motor 250a, a window drive 252, a camera focus slider 254, a camera 256a, and a focus motor 258a. The window drive 252 is coupled to the window motor 250a and operatively engaged with the window cover 210. The window drive 252 is a substantially perpendicular drive. Thus, a window motor rotational axis WM is substantially orthogonal to a window cover rotational axis C. The camera 256a includes one or more sensors (not shown) that convert light and/or images to electrical signals usable by the computing device 160 (shown in FIG. 1).

Referring further to FIG. 4, the window motor 250a is mounted to the case 212 via a first frame mount 260. The window motor 250a, the window drive 252, the camera focus slider 254, and the camera 256a are mounted to the case 212 via a second frame mount 262. The focus motor 258a is mounted to the case 212 via the second frame mount 262 and a third fame mount 264. More specifically, the camera focus slider 254 is slidably engaged with a slider bar 266 connected to a first arm 268 and a second arm 270 of the second frame mount 262. Thus, the first arm 268 and the second arm 270 capture the camera focus slider on the slider bar 266. Further, the camera focus slider 254 is threadably engaged with an adjustment screw 272 rotatably engaged with the first arm 268 and the second arm 270. The adjustment screw 272 is rotatably driven by the focus motor 258a. Additionally, the case 212 defines mounting holes 274 configured to receive fasteners (not shown).

Remaining with FIG. 4, in operation, when the window motor 250a rotates in a first rotational direction 290, the window cover 210 rotates relative to the case 212 in a second rotational direction 292 to align the opening 230 (shown in FIG. 3) with a camera aperture (not shown), which reveals a prism 294 supported by the second frame mount 262. Also in operation, when the window motor 250a rotates in a third rotational direction 296, the window cover 210 rotates relative to the case 212 in a fourth rotational direction 298 to conceal the prism 294. The first rotational direction 290 is opposite the third rotational direction 296. Similarly, the second rotational direction 292 is opposite the fourth rotational direction 298. The window motor 250a includes a first encoder 300a that counts rotations of the window motor 250a.

Looking again at FIG. 4, a focus motor rotational axis FM is substantially orthogonal to the window cover rotational axis C. Further in operation, when the focus motor 258a rotates the adjustment screw 272 in a fifth rotational direction 310, the camera focus slider 254 moves along the adjustment screw 272 and the slider bar 266 in a first axial direction 312. Additionally, in operation, when the focus motor 258a rotates the adjustment screw 272 in a sixth rotational direction 314, the camera focus slider 254 moves along the adjustment screw 272 and the slider bar 266 in a second axial direction 316. The fifth rotational direction 310 is opposite the sixth rotational direction 314. Similarly, the first axial direction 312 is opposite the second axial direction 316. The focus motor 258a includes a second encoder 318a that counts rotations of the focus motor 258a.

Referring again to FIG. 4, the prism 294 orthogonally turns light entering the left camera assembly in the third direction z to the first direction x. Thus, the camera 256a may focus on objects presented to the left camera assembly 150 in the third direction z by translating side to side in the first direction x to according to a focal length of the camera 256a. The prism 294 may have additional optical qualities (clarification, magnification, polarization, etc.) to improve and/or sharpen images presented to the camera 256a.

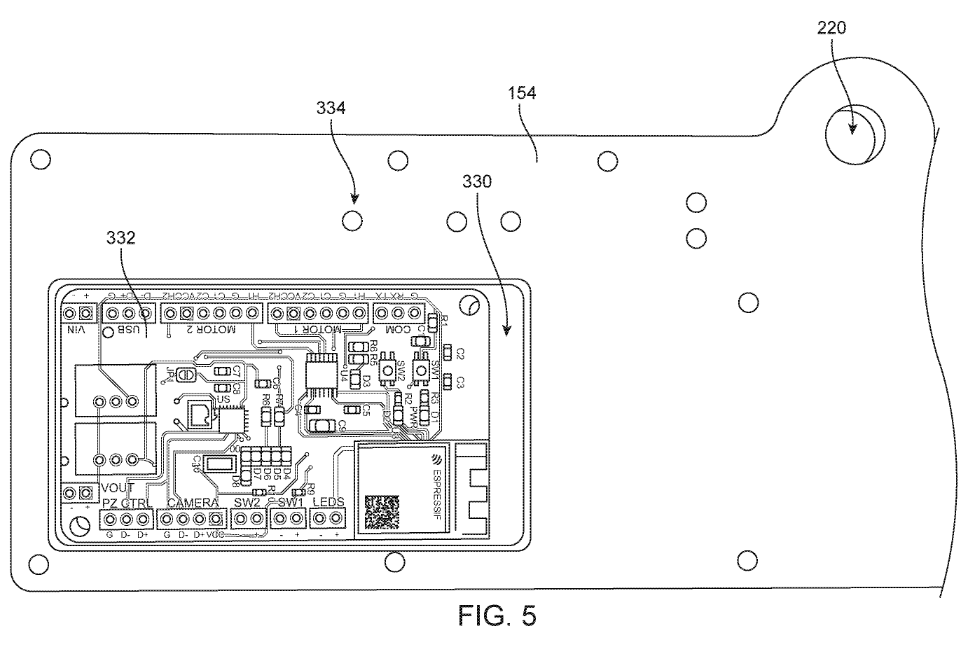

Turning to FIG. 5, the mounting frame 154 defines a recess 330, in which a printed circuit board (PCB) 332 is supported. The PCB 332 is in communication with the window motor 250a, the camera 256a, the focus motor 258a (shown in FIG. 4), and the computing device 160 (shown in FIG. 1). The mounting frame 154 further defines mounting holes 334, through which fasteners (not shown) may extend to mount the left camera assembly 150 to the mounting frame 154 via the case 212 (shown in FIG. 4).

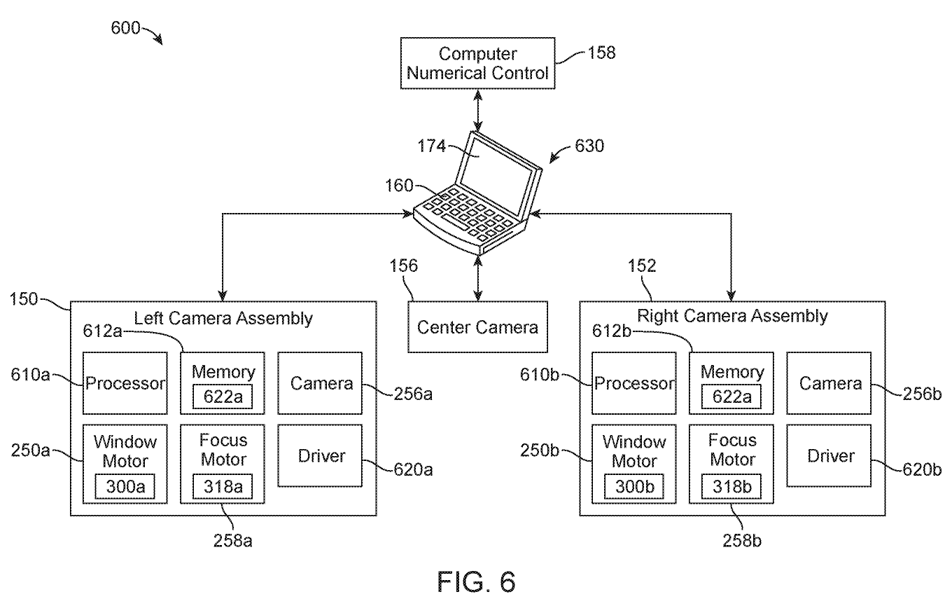

FIG. 6 illustrates electronic components 600 of the lathe system 100 of FIG. 1. The electronic components 600 include the computing device 160 in communication with the left camera assembly 150, the right camera assembly 152, the center camera 156, and the CNC 158. The left camera assembly 150 includes a processor 610a, a memory 612a, the window motor 250a, the camera 256a, the focus motor 258a, and a driver 620a. Similarly, the right camera assembly 152 includes a processor 610b, a memory 612b, a window motor 250b, a camera 256b, a focus motor 258b, and a driver 620b. The window motor 250b and the focus motor 258b include a first encoder 300b and a second encoder 318b, respectively.

Remaining with FIG. 6, the computing device 160 receives rotation counts of the window motors 250a, b and the focus motors 258a, b from the first encoders 300a, b and the second encoders 318a, b, respectively. The computing device 160 communicates with the window motors 250a, b and the drivers 620a, b to open and close the window covers 210 (shown in FIG. 2). Further, the computing device 160 communicates with the focus motors 258a, b and the drivers 620a, b to focus the cameras 256a, b. More specifically, the processors 610a, b determine focal lengths of the cameras 256a, b, based on rotation counts of the focus motors 258a, b from the second encoders 318a, b, and focal length data 622a, b retrieved from the memories 612a, b, respectively. A user may enter commands for the left camera assembly 150, the right camera assembly 152, the center camera 156, and the CNC 158 via an interface 630 shown via the display 174.

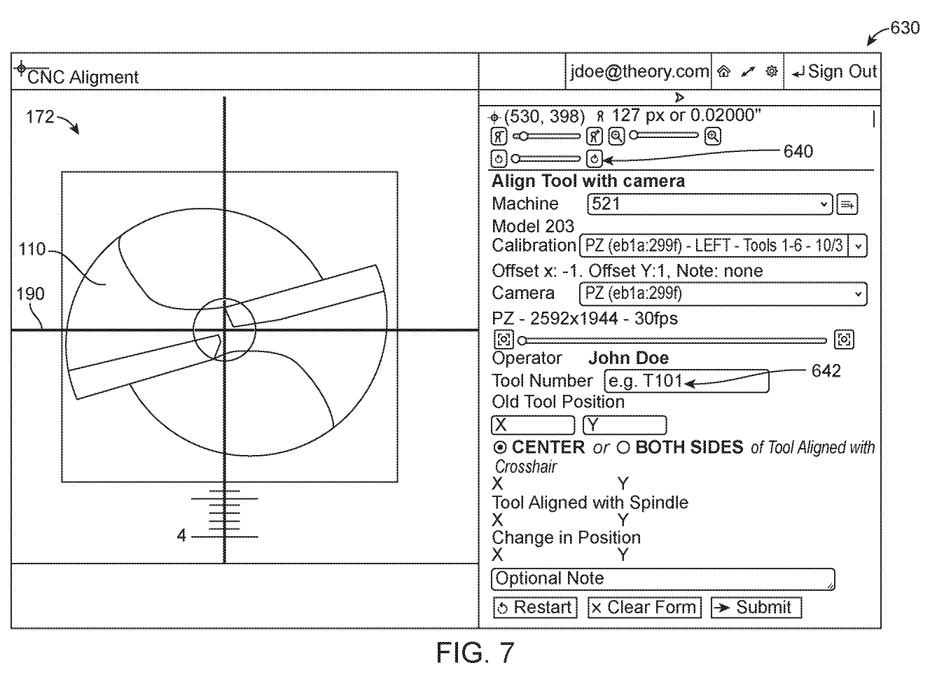

Turning to FIG. 7, the interface 630 displays the image 172 of the tool 110 and the alignment template 190 along with a plurality of control buttons 632 and results indicia 634. The initial calibration of the lathe system 100 and subsequent repeated alignments of the tool 110 described above in conjunction with FIG. 1 may be performed via the interface 630.

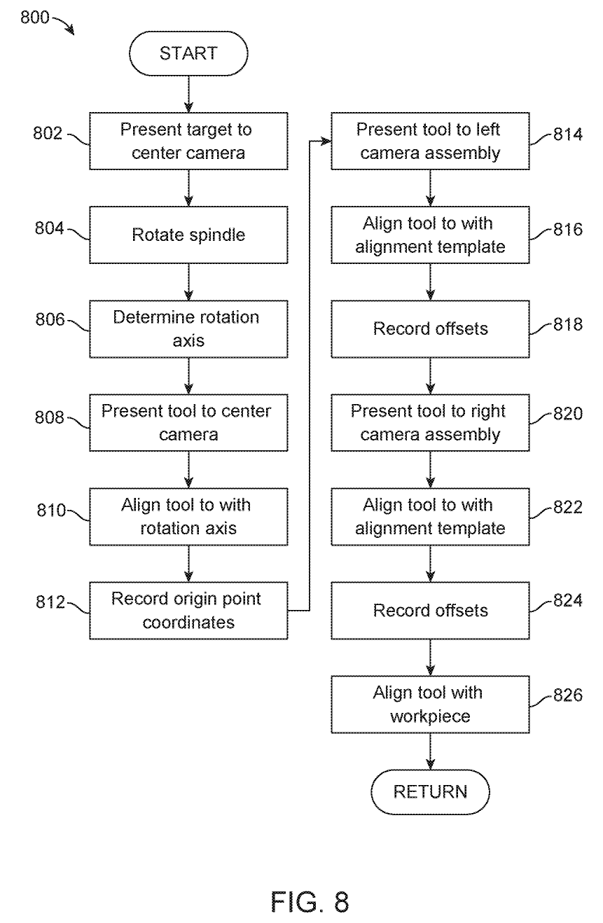

FIG. 8 illustrates a flow diagram depicting a method 800 executable by the computing device 160 of FIG. 1 to align a tool gang within the lathe system of FIG. 1. The method 800 starts at block 802, where the target 170 is presented to the center camera 156. More specifically, the computing device 160 instructs the CNC 158 to translate the tool gang 102 in front of the spindle 104 into which the center camera 156 is placed. The method 800 proceeds to block 804.

At block 804, the spindle 104 is rotated. More specifically, the computing device 160 instructs the CNC 158 to slowly turn the spindle 104. In some instances, the spindle 104 is rotated by hand by a user. The method 800 proceeds to block 806.

At block 806, the rotational axis R of the spindle 104 is determined. More specifically, the computing device 160 analyzes images from the center camera 156 while the spindle 104 rotates and compare light and dark pixels to determine the rotational axis R. The method 800 proceeds to block 808.

At block 808, the tool 110 is presented to the center camera 156. More specifically, the computing device 160 instructs the CNC 158 to translate the tool gang 102, into which the target 170 been replaced by the tool 110, in front of the spindle 104. The method 800 proceeds to block 810.

At block 810, the tool 110 is aligned with the rotation axis R. More specifically, the computing device 160 instructs the CNC 158 to translatably adjust the tool gang 102 until a feature of the tool 110 is aligned with the rotation projection point 178. The method 800 proceeds to block 812.

At block 812, the origin point coordinates are recorded. More specifically, the computing device 160 communicates with the CNC 158 to retrieve and save the coordinates where the tool 110 feature is located in three-dimensional space as the origin point. The method proceeds to block 814.

At block 814, the tool 110 is presented to the left camera assembly 150. More specifically, the computing device 160 instructs the CNC 158 to translate the tool gang 102 in front of the left camera assembly 150. The method 800 proceeds to block 816.

At block 816, the tool 110 is aligned with the alignment template 190. More specifically, the computing device 160 instructs the CNC 158 to translatably adjust the tool gang 102 until the feature of the tool 110 is aligned with the alignment template 190. The method proceeds to block 818.

At block 818, the computing device 160 records the offsets for the left camera assembly 150. More specifically, the computing device 160 communicates with the CNC 158 to retrieve and save the coordinates where the tool 110 feature is located in three-dimensional space relative to the origin point as the left first direction offset Δx1 and the left second direction offset Δy1. The method 800 proceeds to block 820.

At block 820, the tool 110 is presented to the right camera assembly 152. More specifically, the computing device 160 instructs the CNC 158 to translate the tool gang 102 in front of the right camera assembly 152. The method 800 proceeds to block 822.

At block 822, the tool 110 is aligned with the alignment template 190. More specifically, the computing device 160 instructs the CNC 158 to translatably adjust the tool gang 102 until the feature of the tool 110 is aligned with the alignment template 190. The method proceeds to block 824.

At block 824, the computing device 160 records the offsets for the left camera assembly 150. More specifically, the computing device 160 communicates with the CNC 158 to retrieve and save the coordinates where the tool 110 feature is located in three-dimensional space relative to the origin point as the right first direction offset Δx2 and the right second direction offset Δy2. The method 800 proceeds to block 826.

At block 826, the computing device 160 aligns the tool 110 with a workpiece mounted in the spindle 104. the computing device 160 records the offsets for the left camera assembly 150. More specifically, the computing device 160 communicates with the CNC 158 to translatably adjust the tool gang 102 to align with the workpiece in three-dimensional space at the origin point based on the left first direction offset Δx1, the left second direction offset Δy1, the right first direction offset Δx2, and the right second direction offset Δy2. The method 800 returns to block 802.

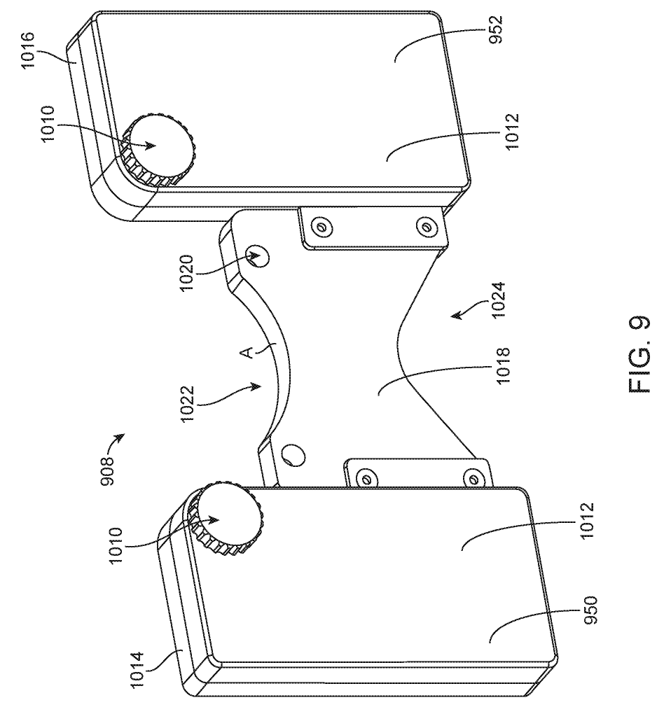

FIG. 9 illustrates a tool alignment device 908 useable with the lathe system 100 of FIG. 1. The tool alignment device 908 includes a left camera assembly 950 and a right camera assembly 952, which are substantially mirror images of one another and thus include reversed, but functionally identical components. Thus, the left camera assembly 950 and the right camera assembly 952 each include a window cover 1010 removably mounted to a case 1012. The left camera assembly 950 is mounted to a first flange 1014. Similarly, the right camera assembly 952 is mounted to a second flange 1016. A mounting section 1018 connects the first flange 1014 and the second flange 1016. The mounting section 1018 defines a plurality of openings 1020 through which threaded fasteners (not shown) may extend. In some embodiments, the mounting section 1018 defines an upper notch 1022 and a lower notch 1024. In some embodiments, the upper notch is arcuate (e.g., circular, ovoid, elliptical, non-polygonal, etc.). In some embodiments, the openings 1020 are defined in the mounting section 1018 outwardly beyond an apex A of the upper notch 1022. In some embodiments, the lower notch 1024 is substantially triangular. More specially, the mounting section 1018 is removably attached to the first flange 1014 and the second flange 1016 fasteners 1026.

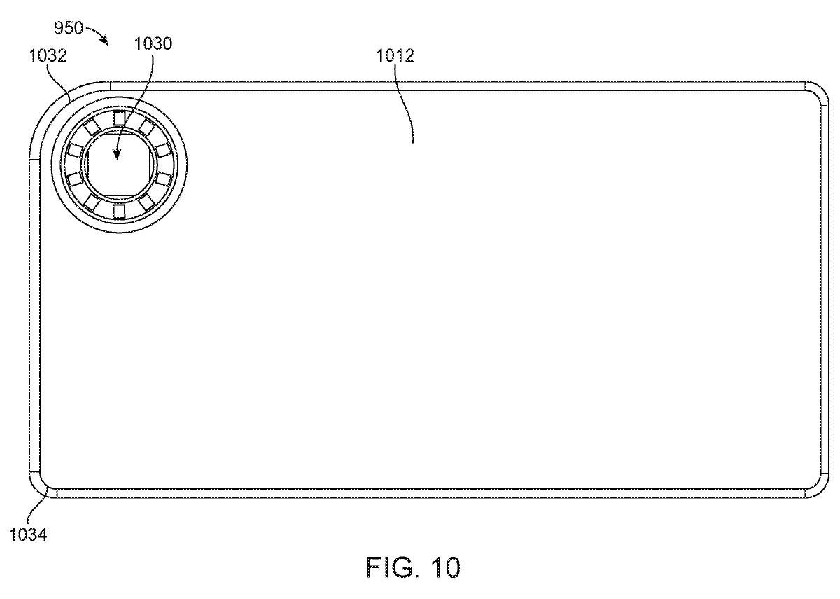

With reference to FIG. 10, in the left camera assembly 950, the case 1012 defines an opening 1030. The case 1012 includes a curved corner 1032 and rounded corners 1034. The curved corner 1032 is concentrically curved with the opening 1030.

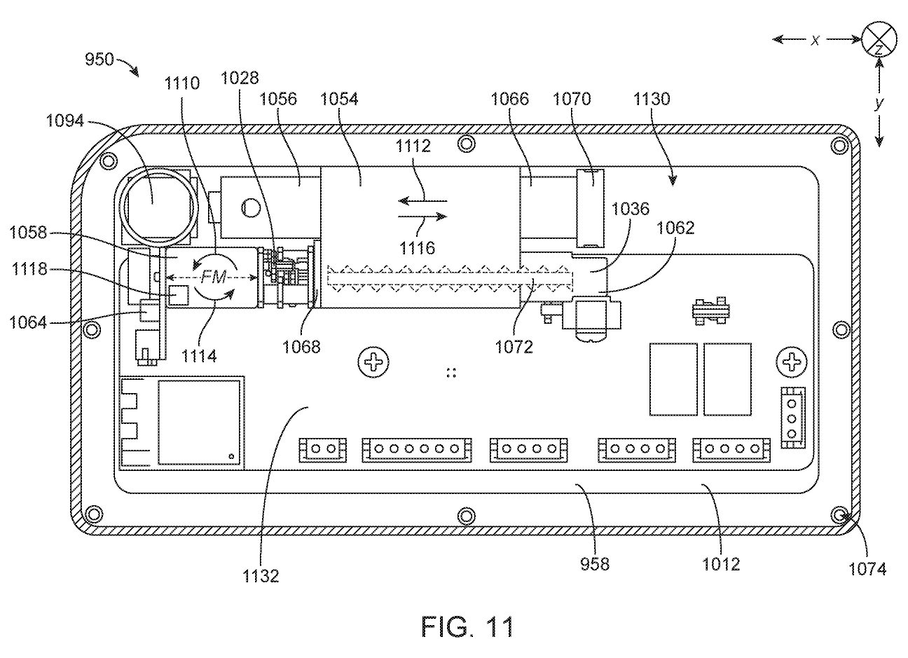

With reference to FIG. 11, the left camera assembly 950 further includes a camera focus slider 1054, a camera 1056, and a focus motor 1058. The camera 1056 includes one or more sensors (not shown) that convert light and/or images to electrical signals usable by the computing device 160 (shown in FIG. 1).

Referring further to FIG. 11, the camera focus slider 1054 and the camera 1056 are mounted to the case 1012 via a first frame mount 1062. The focus motor 1058 is mounted to the case 1012 via the first frame mount 1062 and a second fame mount 1064. More specifically, the camera focus slider 1054 is slidably engaged with a slider bar 1066 and a slider housing 1036 of the first frame mount 1062. Further, the camera focus slider 1054 is threadably engaged with an adjustment screw 1072 (shown in phantom) rotatably disposed within the slider housing 1036. The adjustment screw 1072 is rotatably driven by the focus motor 1058 via a gear train 1028 supported by the first frame mount 1062. Additionally, the case 1012 defines mounting holes 1074 configured to receive fasteners (not shown). The first frame mount 1062 further includes a first stop 1068 and second stop 1070 that capture and thus delimit sliding movement of the camera focus slider 1054 along the slider bar 1066 and the slider housing 1036.

Looking again at FIG. 11, the focus motor 1058 defines a focus motor rotational axis FM that is substantially colinear and/or parallel to the adjustment screw 1072. Further in operation, when the focus motor 1058 rotates the adjustment screw 1072 in a first rotational direction 1110, the camera focus slider 1054 moves along the adjustment screw 1072, the slider housing 1036, and the slider bar 1066 in a first axial direction 1112. Additionally, in operation, when the focus motor 1058 rotates the adjustment screw 1072 in a second rotational direction 1114, the camera focus slider 1054 moves along the adjustment screw 1072, the slider housing 1036, and the slider bar 1066 in a second axial direction 1116. The first rotational direction 1110 is opposite the second rotational direction 1114. Similarly, the first axial direction 1112 is opposite the second axial direction 1116. The focus motor 1058 includes an encoder 1118a that counts rotations of the focus motor 1158.

Referring again to FIG. 11, a prism 1094 orthogonally turns light entering the left camera assembly 950 in the third direction z to the first direction x. Thus, the camera 1056 may focus on objects presented to the left camera assembly 950 in the third direction z by translating side to side in the first direction x to according to a focal length of the camera 1056. The prism 1094 may have additional optical qualities (clarification, magnification, polarization, etc.) to improve and/or sharpen images presented to the camera 1056.

Remaining with FIG. 11, the case 1012 defines a recess 1130, in which a printed circuit board (PCB) 1132 is supported. The PCB 1132 is in communication with the camera 1056, the focus motor 1058, and the computing device 160 (shown in FIG. 1).

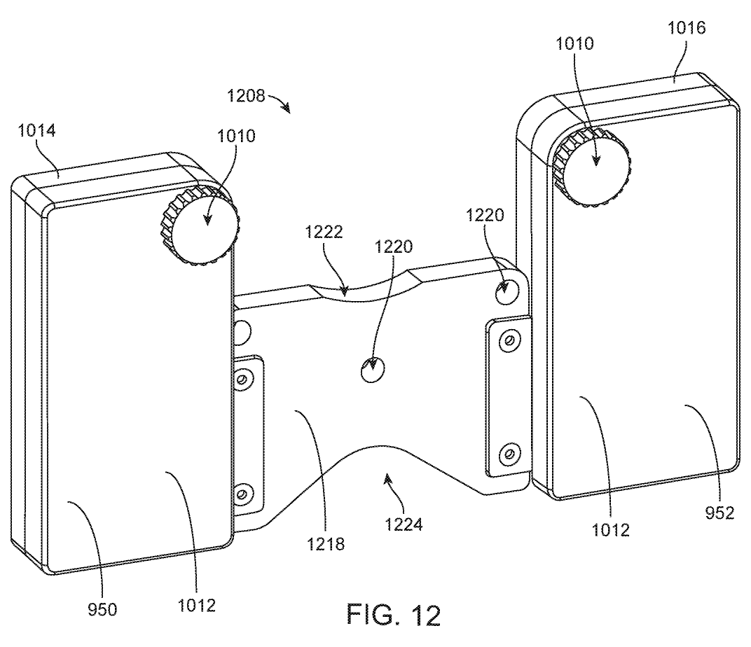

FIG. 12 illustrates a tool alignment device 1208 useable with the lathe system 100 of FIG. 1. The tool alignment device 1208 includes the left camera assembly 950 and the right camera assembly 952. The left camera assembly 950 is mounted to the first flange 1014. Similarly, the right camera assembly 952 is mounted to the second flange 1016. A mounting section 1218 connects the first flange 1014 and the second flange 1016. The mounting section 1218 defines a plurality of openings 1220 through which threaded fasteners (not shown) may extend. In some embodiments, the mounting section 1218 defines an upper notch 1222 and a lower notch 1224. In some embodiments, the upper notch is arcuate (e.g., circular, ovoid, elliptical, non-polygonal, etc.). In some embodiments, the lower notch 1224 is substantially triangular. In some embodiments, at least one of the openings 1220 is centrally located along the mounting section 1218. More specially, the mounting section 1218 is removably attached to the first flange 1014 and the second flange 1016 via fasteners 1026.

In other embodiments, other configurations are possible. For example, those of skill in the art will recognize, according to the principles and concepts disclosed herein, that various combinations, sub-combinations, and substitutions of the components discussed above can provide improved methods and devices for to locating and aligning machine tools.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An alignment tool comprising:
a camera assembly configured to be installed offset from a rotational axis; and
a computing device in communication with the camera assembly and configured to determine a directional offset of a tool presented to the camera assembly relative to the rotational axis.

2. The alignment tool of claim 1, wherein the camera assembly is supported by a mounting frame.

3. The alignment tool of claim 2, wherein the mounting frame includes an arcuate mounting section.

4. The alignment tool of claim 1, wherein the camera assembly includes a camera translatably moveable in a direction substantially perpendicular to the rotational axis.

5. The alignment tool of claim 4, wherein translating the camera along the direction focuses the camera.

6. The alignment tool of claim 4, wherein a motor translates the camera via an adjustment screw.

7. The alignment tool of claim 6, wherein a camera focus slider supports the camera, is threadably engaged with the adjustment screw, and is slidably engaged with a slider bar.

8. The alignment tool of claim 1, wherein the camera assembly includes a prism configured to orthogonally turn light entering the camera assembly.

9. The alignment tool of claim 8, wherein the prism presents images to a camera in a direction orthogonal to the rotational axis.

10. The alignment tool of claim 9, wherein
the camera is slidably supported by a mounting frame, and
the prism is supported by the mounting frame.

11. The alignment tool of claim 1, wherein the camera assembly includes a selectively openable window cover.

12. The alignment tool of claim 11, wherein a motor opens the window cover via an orthogonal drive.

13. The alignment tool of claim 11, wherein the window cover defines an opening configured to selectively align with a camera aperture.

14. The alignment tool of claim 13, wherein the camera aperture reveals a prism.

15. The alignment tool of claim 1, wherein the computing device is configured to align the tool with a workpiece mounted along the rotational axis based on the directional offset.

16. A camera assembly comprising:
a case;
a camera translatably supported by the case;
a prism aligned with the camera; and
a window cover rotatably mounted to the case and configured to selectively reveal the prism.

17. The camera assembly of claim 16, wherein the camera is drivably connected to a focus motor and the window cover is drivably connected to a window motor.

18. The camera assembly of claim 17, wherein a frame mount connected to the case supports the camera, the prism, the focus motor, and the window motor.

19. A method to align a tool gang within a lathe system, the method comprising:
rotating a spindle of the lathe system;
determining a rotational axis of the spindle based on images from a first camera;
aligning a tool mounted in the tool gang with the rotational axis based on images from the first camera;
aligning the tool with an alignment template based on images from a second camera; and
determining a directional offset between the tool and the rotational axis.

20. The method of claim 19, further comprising aligning the tool with a workpiece mounted in the spindle based on the directional offset.
